(19) United States
(12) Patent Application Publication
(10) Pub. No.: US 2016/0380313 A1
(43) Pub. Date: Dec. 29, 2016

(54) BATTERY PACK, CONTROL CIRCUIT, AND CONTROL METHOD

(71) Applicant: Kabushiki Kaisha Toshiba, Minato-ku (JP)

(72) Inventors: Tomokazu MORITA, Funabashi (JP); Mitsunobu YOSHIDA, Kawasaki (JP); Ena ISHll, Yokohama (JP); Nobukatsu SUGIYAMA, Kawasaki (JP)

(73) Assignee: Kabushiki Kaisha Toshiba, Minato-ku (JP)

(21) Appl. No.: 15/260,805

(22) Filed: Sep. 9, 2016

Related U.S. Application Data
(63) Continuation of application No. PCT/JP2014/073665, filed on Sep. 8, 2014.

(51) Int. Cl. H01M 10/42; H01M 10/48; H01M 10/0525

(52) U.S. Cl. CPC H01M 10/425; H01M 10/0525; H01M 10/486; H01M 10/48; H01M 2010/4271; H01M 2010/4278; H01M 2200/00; H01M 2200/10

(57) ABSTRACT

According to an embodiment, a battery pack includes an initial state estimation unit, a temperature estimation unit, and a determination unit. The internal state estimation unit estimates an internal state of a secondary battery based on measurement data. The temperature estimation unit estimates the temperature of the secondary battery based on the measurement data and the estimation parameter. The determination unit compares an absolute value of a temperature difference between a measured temperature of the secondary battery contained in the measurement data and the estimated temperature with one or more temperature threshold levels, and determines a temperature state of the secondary battery in accordance with a comparison result.

### CROSS-REFERENCE TO RELATED APPLICATIONS

This application is a Continuation Application of PCT Application No. PCT/JP2014/073665, filed Sep. 8, 2014, the entire contents of which are incorporated herein by reference.

### FIELD

Embodiments described herein relate generally to a battery pack including a secondary battery.

### BACKGROUND

A nonaqueous electrolyte secondary battery such as a lithium-ion secondary battery has a high energy density. Therefore, the nonaqueous electrolyte secondary battery has typically been used as the power supply of a portable electronic apparatus. Recently, the applications of the nonaqueous electrolyte secondary battery expand to the energy sources of hybrid transport apparatuses (e.g., a hybrid vehicle and hybrid two-wheeler) or electric transport apparatuses (e.g., an electric vehicle and electric bike). In addition, the use of the nonaqueous electrolyte secondary battery as a large-scale power storage battery has seriously been examined.

A single cell is normally used as the power supply of a small electronic apparatus such as a cell phone. On the other hand, an assembled battery in which a plurality of cells are connected in series or parallel is used as the power supply of a larger electronic apparatus, the energy source of a transport apparatus, and the storage battery of a large-scale power system. More specifically, an assembled battery in which several cells are connected is used in a laptop PC (Personal Computer), an assembled cell in which about a few tens of cells to a few hundred cells are connected is used as an electric vehicle storage battery or household stationary storage battery, and an assembled battery in which 10,000 or more cells are connected is used as a power system storage battery.

The nonaqueous electrolyte secondary battery has a high energy density, but is likely to abnormally generate heat if overcharge occurs due to abnormality of a cell, a peripheral part (e.g., a motor, an inverter, or a CPU (Central Processing Unit)) or a peripheral circuit of the cell. If this abnormal heat is left untreated, it may lead to smoke, fire, or the like. Generally, therefore, a plurality of security means (e.g., a use stopping means) are prepared to ensure the safety of the nonaqueous electrolyte secondary battery. Many security means function based on the voltage or temperature of a cell.

For example, a battery management system (BMU) for controlling an assembled battery controls a peripheral component such as a cell balancer for holding the charged state and discharged state of each cell uniform, in addition to management of the electric current and voltage of each cell, thereby operating the assembled battery while maintaining a safe charged state and discharged state (i.e., while preventing overcharge and overdischarge).

Furthermore, a temperature protection device is also used as a security means. The temperature protection device prevents abnormal heat generation by restricting or stopping a charge/discharge operation under the condition that the cell temperature is equal to or higher than a temperature threshold. The temperature protection device includes a temperature fuse which physically cuts off an electric current by fusing at a high temperature, a PTC (Positive Temperature Coefficient) thermistor for limiting an electric current by raising the resistance value at a high temperature, and an excessive temperature rise preventing circuit for stopping the charge/discharge operation if the measurement value of a temperature sensor becomes equal to or higher than a temperature threshold.

Unfortunately, if the temperature protection device like this functions by mistake when the battery is normally used, the user's convenience largely degrades. To avoid this event, the temperature threshold at which the temperature protection device functions is typically set at a very high temperature which is not reached when the battery is normally used. The user's convenience is maintained by thus setting the temperature threshold at a high temperature, but there is the possibility that the temperature protection device does not function unless the battery pack or its periphery is unrestorably damaged.

In addition, the operation period of a transport apparatus assembled battery or large-scale power storage assembled battery is supposed to be about 10 to 15 years, but the battery characteristics deteriorate with time. That is, the characteristics of each cell, the cell performance distribution in an assembled battery, and the like change during the operation period of the assembled battery. Accordingly, to ensure the safety of an assembled battery for a long time period, the security means preferably functions by taking account of the deterioration of the battery characteristics.

### BRIEF DESCRIPTION OF THE DRAWINGS

FIG. 1 is a block diagram showing an example of a battery pack according to an embodiment.

FIG. 2 is a block diagram showing an example of a calculation unit shown in FIG. 1.

FIG. 3 is a flowchart showing an example of an abnormal heat generation detection process to be executed in the battery pack.

FIG. 4 is a graph showing an example of a charge/discharge curve of a secondary battery.

FIG. 5 is a graph showing an example of the internal state of the secondary battery.

FIG. 6 is a graph showing examples of an OCV curve and entropy curve when a cathode active material is lithium cobalt oxide (LiCoO₂).

FIG. 7 is a graph showing examples of the OCV curve and entropy curve when the cathode active material is lithium manganate (LiMn₂O₄).

FIG. 8 is a graph showing examples of the OCV curve and entropy curve when the cathode active material is Li(NiCoMn)O₂.

FIG. 9 is a graph showing examples of the OCV curve and entropy curve when the cathode active material is olivine type lithium iron phosphate (LiFePO₄).

FIG. 10 is a graph showing examples of the OCV curve and entropy curve when an anode active material is graphite (LiC₆).

FIG. 11 is a graph showing examples of the OCV curve and entropy curve when the anode active material is lithium titanate (Li₄Ti₅O₁₂).

FIG. 12 is a graph showing examples of actual measurement data of the electric current, voltage, and temperature of the battery.

FIG. 13 is a graph showing examples of changes in measured temperature and estimated temperature with time of the battery.

FIG. 14 is a graph showing examples of changes in temperature difference and temperature threshold with time.

### DETAIL DESCRIPTION

Embodiments will be explained below with reference to the accompanying drawings.

According to an embodiment, a battery pack includes a secondary battery, a measurement unit, an initial state estimation unit, a temperature estimation unit, and a determination unit. The measurement unit measures an electric current, a voltage, and a temperature of the secondary battery, and an environmental temperature outside the secondary battery to obtain measurement data. The internal state estimation unit estimates an internal state of the secondary battery based on the measurement data to obtain an estimation parameter. The temperature estimation unit estimates the temperature of the secondary battery based on the measurement data and the estimation parameter to obtain an estimated temperature. The determination unit compares an absolute value of a temperature difference between a measured temperature of the secondary battery contained in the measurement data and the estimated temperature with one or more temperature threshold levels, and determines a temperature state of the secondary battery in accordance with a comparison result.

Note that in the following description, the same or similar reference numerals denote elements which are the same as or similar to already explained elements, and a repetitive explanation will basically be omitted.

### First Embodiment

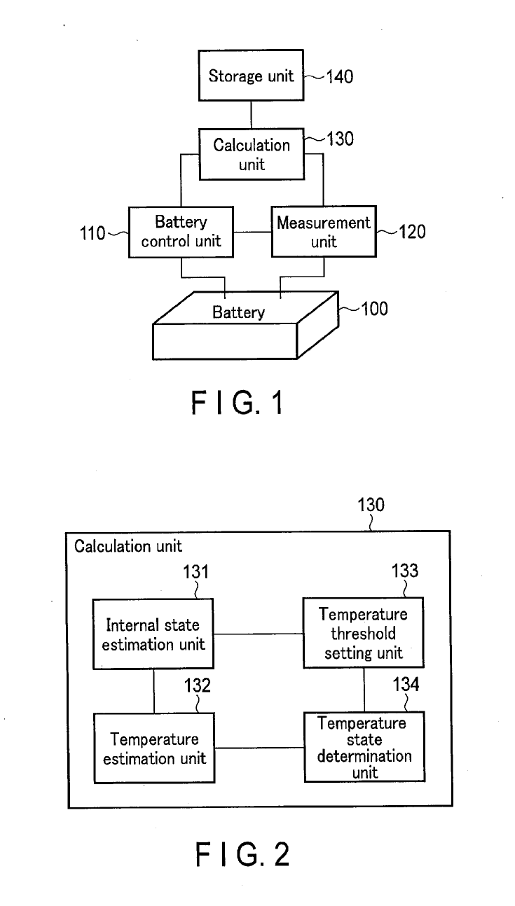

As exemplarily shown in FIG. 1, a battery pack according to the first embodiment includes a battery 100, a battery control unit 110, a measurement unit 120, a calculation unit 130, and a storage unit 140. Note that some or all of the battery control unit 110, measurement unit 120, calculation unit 130, and storage unit 140 may also be installed as an external control circuit of the battery pack. It is also possible to collectively regard this control circuit and the battery pack as a battery management system.

The battery 100 can be a single cell, and can also be an assembled battery in which a plurality of cells are connected in series or parallel. In the following explanation, the battery 100 is an assembled battery. Each cell is preferably a nonaqueous electrolyte secondary battery such as a lithium-ion secondary battery.

The battery control unit 110 performs input/output control of the battery 100. More specifically, the battery control unit 110 controls the electric current and voltage of the battery 100.

The measurement unit 120 measures the electric current, voltage, and temperature (e.g., the surface temperature of a cell) of the battery 100. More specifically, the measurement unit 120 can measure the electric current, voltage, and temperature of each cell, or the electric current, voltage, and temperature of each cell group including a plurality of cells. For example, when the battery 100 includes a plurality of series-connected battery stages and a plurality of cells are connected in parallel in each battery stage, each battery stage (i.e., the plurality of parallel-connected cells) can be handled as a cell group. The measurement unit 120 also measures the external environmental temperature (e.g., the temperature of the case of the battery pack) of the battery 100. The measurement unit 120 outputs the measurement data (i.e., the measured electric current, measured voltage, measured temperature, and measured environmental temperature) of the battery 100 to the calculation unit 130.

The measurement unit 120 can measure the temperature by using, e.g., a thermistor, thermocouple, resistance temperature detector, or temperature sensor IC (Integrated Circuit). Note that when a cooling mechanism or heat radiation mechanism (not shown) acts on the battery 100, the measurement unit 120 can further measure the temperature of a refrigerant or the temperature of the outdoor air to be used in air cooling. By using the temperature of the cooling mechanism or heat radiation mechanism, the calculation unit 130 can accurately calculate the heat radiation amount of the battery 100 (to be described later).

The calculation unit 130 receives the measurement data from the measurement unit 120, and reads out OCV (Open Circuit Voltage) data and entropy data (to be described later) from the storage unit 140. The calculation unit 130 performs, e.g., regression analysis of a charge/discharge curve based on the measurement data and OCV data, thereby estimating the internal state parameters such as the cathode active material amount, anode active material amount, internal resistance value, cathode SOC (State Of Charge), anode SOC, and cell SOC for each cell or each cell group. In addition, based on the measurement data, entropy data, and estimated internal state parameters, the calculation unit 130 thermologically estimates the theoretical temperature of the battery 100 for each cell or each cell group. Then, the calculation unit 130 calculates a temperature difference between the estimated temperature and measured temperature of the battery 100, and determines the temperature state of the battery 100 for each cell or each cell group by comparing the temperature difference with at least one temperature threshold level. Note that the calculation unit 130 can set the abovementioned at least one temperature threshold level as needed. When a plurality of temperature threshold levels are set, an abnormal state can be determined level by level. After that, a security operation on a level suitable for the risk is adopted. This makes it possible to maintain the user's convenience while ensuring the safety of the battery pack and its peripheral components and circuits.

The storage unit 140 stores the OCV data and entropy data of the cathode active material of the battery 100, and the OCV data and entropy data of the anode active material of the battery 100. The OCV data of an active material represents an OCV curve indicating the relationship between the OCV of the active material and the charged state. The entropy data of an active material represents an entropy curve indicating the relationship between the entropy of the active material and the charged state.

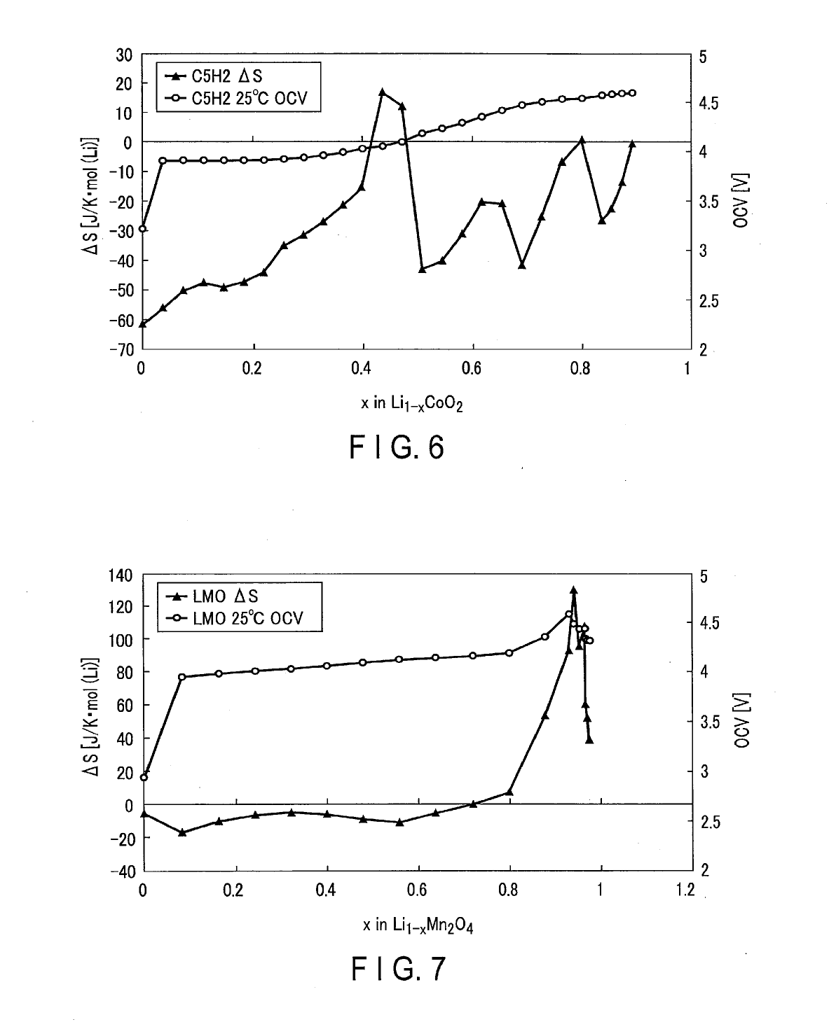

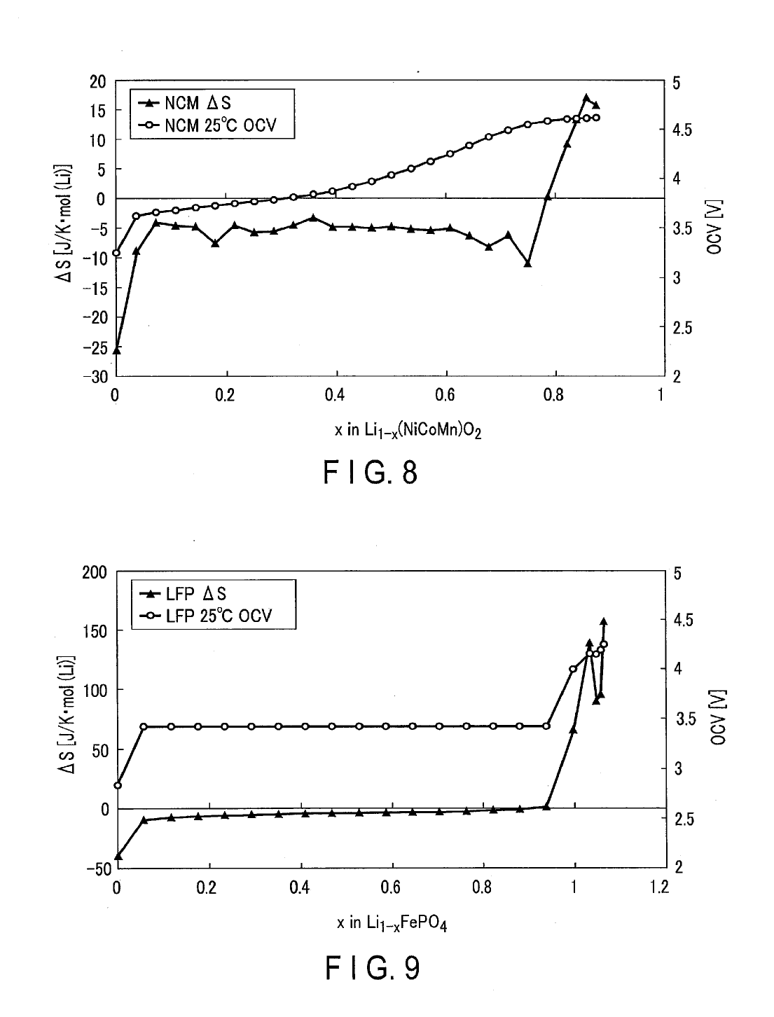

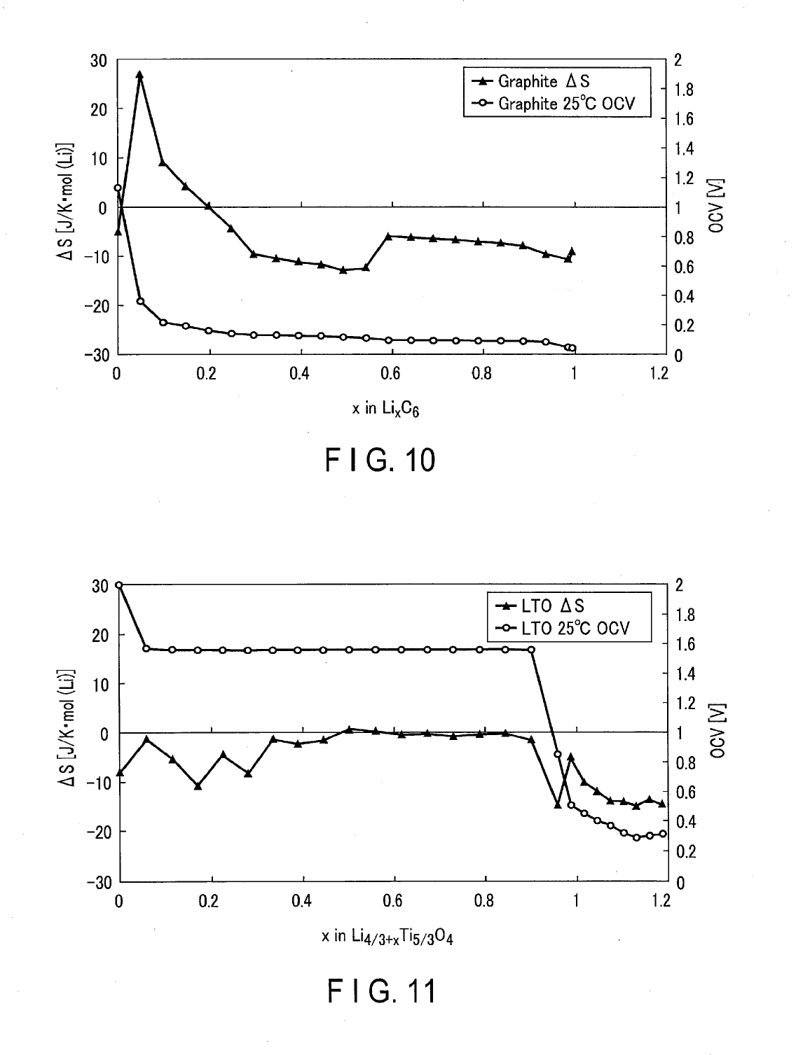

FIGS. 6 to 11 show practical examples of the OCV curve and entropy curve. FIGS. 6, 7, 8, and 9 show examples of the OCV curve and entropy curve when the cathode active materials are respectively lithium cobalt oxide (LiCoO₂), lithium manganate (LiMn₂O₄), Li(NiCoMn)O₂, and olivine type lithium iron phosphate (LiFePO₄). FIGS. 10 and 11 show examples of the OCV curve and entropy curve when the anode active materials are respectively graphite (LiC₆) and lithium titanate (Li₄Ti₅O₁₂).

As shown in FIGS. 6 to 11, the behaviors of entropy change amounts (ΔS) are largely different depending on active materials. More specifically, lithium cobalt oxide and graphite are active materials having relatively large entropy change amounts (ΔS), and lithium manganate, olivine type lithium iron phosphate, and lithium titanate are active materials having relatively small entropy change amounts (ΔS) (close to 0). Therefore, when, for example, the cathode and anode of the battery 100 mainly contain active materials having relatively small entropy change amounts (ΔS), the calculation unit 130 can approximate an entropy endothermic/exothermic amount (to be described later) to 0. Furthermore, the calculation unit 130 can estimate the temperature of the battery 100 without referring to the entropy data in this case.

Note that the OCV curve and entropy curve of an active material can be derived by forming an experiment cell, and measuring and calculating the open circuit voltage and entropy change amount (ΔS) in various charged states of the experiment cell. The experiment cell includes an electrode containing an active material, conductive material, and binder as a counterelectrode, and Li as a reference electrode. After a sufficient pause time since this experiment cell is set in a given charged state, the open circuit voltage (E(T)) is measured while changing the temperature (T) step by step. In addition, the entropy change amount (ΔS) is calculated by substituting the temperature (T) and open circuit voltage (E(T)) for those in equation (1) below. The open circuit voltage and entropy change amount are similarly measured and calculated for other charged states.

$$E ( T ) = E 0 - \frac{Δ T \cdot Δ S}{F} \qquad ( 1 )$$

Note that in equation (1), E0 represents the open circuit voltage at a reference temperature, ΔT represents the difference between the reference temperature and temperature (T), and F represents a Faraday constant.

As exemplarily shown in FIG. 2, the calculation unit 130 can functionally be divided into an internal state estimation unit 131, a temperature estimation unit 132, a temperature threshold setting unit 133, and a temperature state determination unit 134.

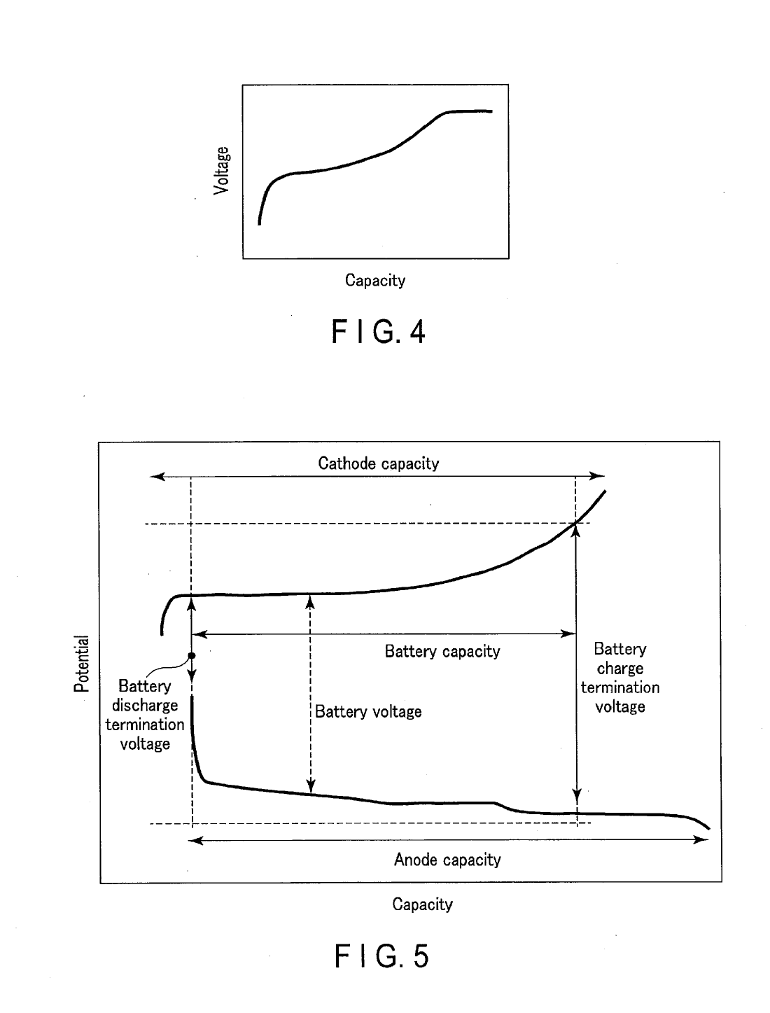

The internal state estimation unit 131 receives the measurement data from the measurement unit 120, and reads out the OCV data from the storage unit 140. The internal state estimation unit 131 performs fitting calculations on the shape of a charge/discharge curve based on the OCVs of the cathode and anode active materials by using, e.g., the internal resistance value and the cathode and anode active material amounts as parameters, thereby estimating these parameters. The internal state estimation unit 131 estimates, e.g., an internal state shown in FIG. 5 with respect to a charge/discharge curve shown in FIG. 4.

Even when the cathode or anode contains a plurality of active materials, regression analysis of the charge/discharge curve enables the internal state estimation unit 131 to estimate the individual internal state (particularly, the deterioration state) of each active material. Consequently, the temperature estimation unit 132 can accurately estimate the entropy endothermic/exothermic amount proportional to each active material amount.

Furthermore, when the battery 100 is an assembled battery, regression analysis of the charge/discharge curve is favorable because the individual internal state can be estimated for each cell or each cell group. Since the internal states of cells in the assembled battery vary due to deterioration with time, the thermal behaviors of cells are not uniform when the assembled battery is charged and discharged. Accordingly, it is preferable to estimate the individual internal state for each cell or each cell group, and reproduce the thermal behavior of each cell or each cell group. Note that the BMU measures the voltage of each cell as a safety measure in a general assembled battery as well. Therefore, no large design change is necessary even when the measurement unit 120 measures the voltage for each cell or each cell group.

Generally, the charge operation conditions of the battery 100 are simpler than the discharge operation conditions. For example, the battery 100 is charged to a predetermined voltage by a constant current, and then charged by a constant voltage (CC−CV). On the other hand, discharge of the battery 100 typically means load driving, and the operation conditions are more complicated because the electric current is not necessarily constant. Accordingly, the internal state estimation unit 131 preferably analyzes the charge curve, but can also analyze the discharge curve.

The temperature estimation unit 132 receives the measurement data from the measurement unit 120, receives the estimated internal state parameters from the internal state estimation unit 131, and reads out the entropy data from the storage unit 140. Based on the measurement data, entropy data, and estimated internal state parameters, the temperature estimation unit 132 thermologically estimates the theoretical temperature of the battery 100. However, if the cathode and anode of the battery 100 mainly contain active materials having relatively small entropy change amounts (ΔS), the temperature estimation unit 132 may also approximate the entropy endothermic/exothermic amount to 0. In this case, the temperature estimation unit 132 does not read out the entropy data from the storage unit 140.

More specifically, the temperature estimation unit 132 calculates the temperature change (ΔTc) within a unit period of a cell (or cell group) being used (i.e., being charged or discharged), by dividing the heat quantity balance (Q) within the unit period of the cell by the heat capacity (C) of the cell, as indicated by equation (2) below:

$$Δ Tc = \frac{Q}{C} \qquad ( 2 )$$

The temperature estimation unit 132 calculates the sum total of the Joule heating value, the entropy endothermic/exothermic amount, and the outside heat radiation amount in a cell, as the heat quantity balance of the cell, as indicated by equation (3) below:

$$Q = Joule heating value + entropy endothermic / exothermic amount + outside heat radiation amount \qquad ( 3 )$$

The temperature estimation unit 132 calculates the first term (Joule heating value) on the right side of equation (3) in accordance with equation (4) below:

Joule heating value=I²×R (4)
where I represents the electric current. I takes a positive value during charge, and a negative value during discharge. R represents the internal resistance value. Note that the internal resistance value (R) is the function of the cell state (i.e., the cell temperature (Tc) and cell SOC (SOCc)), so equation (4) can be rewritten into equation (5) below:

Joule heating value=I²×R(Tc,SOCc) (5)

The temperature estimation unit 132 calculates the second term (entropy endothermic/exothermic amount) on the right-hand side of equation (3) in accordance with equation (6) below:

$$entropy endothermic / exothermic amount = \frac{I}{F} \cdot Tc \cdot ( Δ Sp - Δ Sn ) \qquad ( 6 )$$

where ΔSₚ represents the entropy change amount of the cathode, and ΔSₙ represents the entropy change amount of the anode. The entropy endothermic/exothermic amount is caused by a change in Li composition in an active material when the active material is charged and discharged. Therefore, the cathode entropy change amount and anode entropy change amount are respectively the functions of the cathode SOC (SOCₚ) and anode SOC (SOCₙ), so equation (6) can be rewritten to equation (7) below:

$$entropy endothermic / exothermic amount = \frac{I}{F} \cdot Tc \cdot ( Δ Sp ( SOCp ) - Δ Sn ( SOCn ) ) \qquad ( 7 )$$

The temperature estimation unit 132 calculates the third term (the outside heat radiation amount) on the right side of equation (3) in accordance with equation (8) below:

outside heat radiation amount=H×(Tc−Te) (8)
where H represents the heat transfer coefficient, and Te represents the environmental temperature.

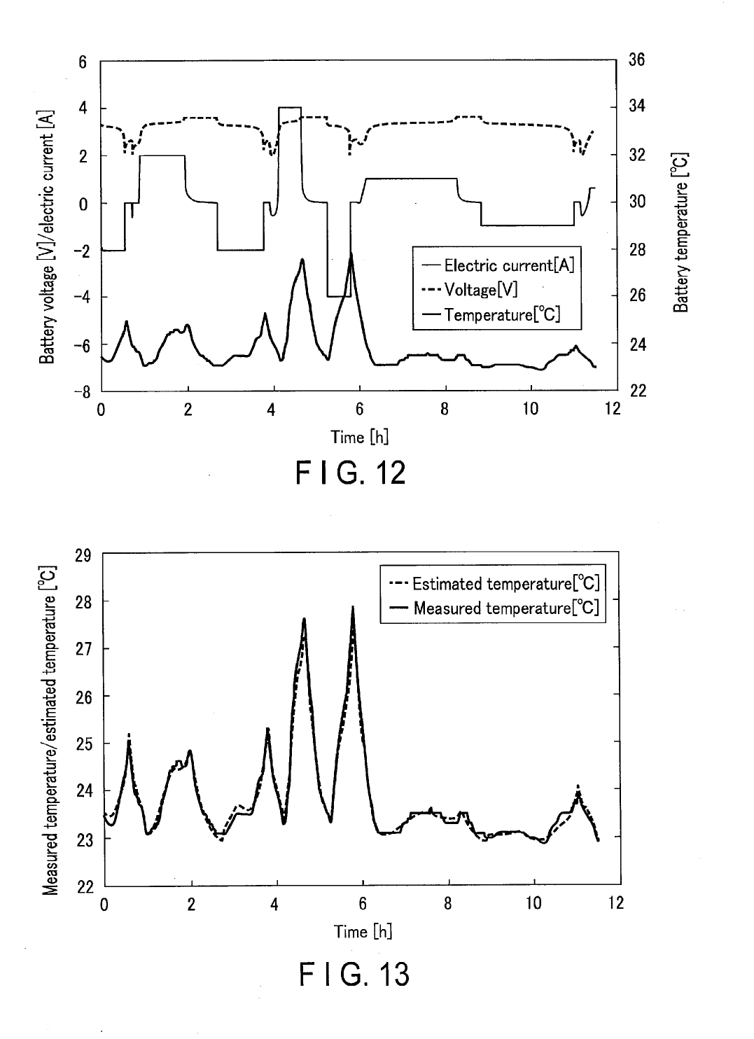

For example, an estimated temperature shown in FIG. 13 can be derived based on measurement data shown in FIG. 12. FIG. 12 shows fluctuations in surface temperature with time of the battery 100 containing olivine type lithium iron phosphate as the cathode active material and graphite as the anode active material, and having a capacity of about 2 Δh, when charge and discharge were performed by setting the value of an electric current at 1 C, 2 C, and 0.5 C. As shown in FIG. 12, a maximum temperature fluctuation caused by charge/discharge was about 4° C. Note that the temperature increased and decreased while a constant current was applied mainly because of the influence of the entropy change of graphite as the anode active material.

The temperature of the battery 100 can be estimated by calculating the temperature change within the unit time in accordance with equation (2), and accumulating the temperature changes. More specifically, the estimated temperature shown in FIG. 13 was derived by calculating Q in equation (2) in accordance with equation (9) below:

$$Q = ( V - OCV ) \times I - \frac{I}{F} \cdot Tc \cdot Δ Sn ( SOCn ) + H \times ( Tc - Te ) \qquad ( 9 )$$

where V represents the voltage of the battery 100, and OCV represents the OCV of the battery 100. The first term on the right-hand side of equation (9) is apparently different from both equations (4) and (5). Since, however, equation (10) below holds in accordance with Ohm's law, equation (9) is consistent with equations (4) and (5). Also, since olivine type lithium iron phosphate as the cathode active material has a relatively small entropy change amount, the entropy endothermic/exothermic amount of the cathode is approximated to 0.

I²R=(V−OCV)×I (10)

As shown in FIG. 13, the estimated temperature generally matches the measurement temperature in respect of the fluctuation width and fluctuation direction. In particular, an estimation error is at most 1° C. even in 2 C charge/discharge during which the fluctuation is intense. That is, the temperature estimation unit 132 can accurately estimate the theoretical temperature of the battery 100 as long as the battery 100 is normally operating.

Note that in general, when a cell has deteriorated with time, the capacity of the cell reduces, its internal resistance value increases, and a difference is produced between the cathode SOC and anode SOC. Therefore, the internal state estimation unit 131 preferably re-estimates (i.e., updates) the internal state parameters at an appropriate frequency, so the temperature estimation accuracy of the temperature estimation unit 132 does not decrease due to the influence of deterioration with time.

The temperature threshold setting unit 133 receives the measurement data from the measurement unit 120, and receives the estimated internal state parameters from the internal state estimation unit 131. Based on, e.g., the electric current, cell SOC, cell temperature, and environmental temperature, the temperature threshold setting unit 133 adjusts at least one temperature threshold level, and sets the adjusted temperature threshold.

Note that when the temperature state determination unit 134 determines the temperature state of the battery 100 by using a fixed temperature threshold, the temperature threshold setting unit 133 may also be omitted. However, it is possible to compensate for fluctuations in estimation error in the temperature estimation unit 132 by using a variable temperature threshold, so the temperature state of the battery 100 can be determined more appropriately. More specifically, when the battery 100 is not in use or is used moderately, the estimation error in the temperature estimation unit 132 hardly increases. Therefore, a temperature state determination error hardly occurs even if the temperature threshold setting unit 133 decreases the absolute value of the temperature threshold. On the other hand, when the battery 100 is used very hard (e.g., when the electric current itself or its fluctuation is large), the estimation error tends to increase, so it is preferable to suppress the occurrence of the temperature state determination error by increasing the absolute value of the temperature threshold by the temperature threshold setting unit 133.

More specifically, the temperature threshold setting unit 133 adjusts the temperature threshold in accordance with the functions of some or all of the parameters such as the value of the electric current, the temperature difference between the cell temperature and environmental temperature, the cell SOC, and the variations in internal states and charged stages of the cells in the battery 100.

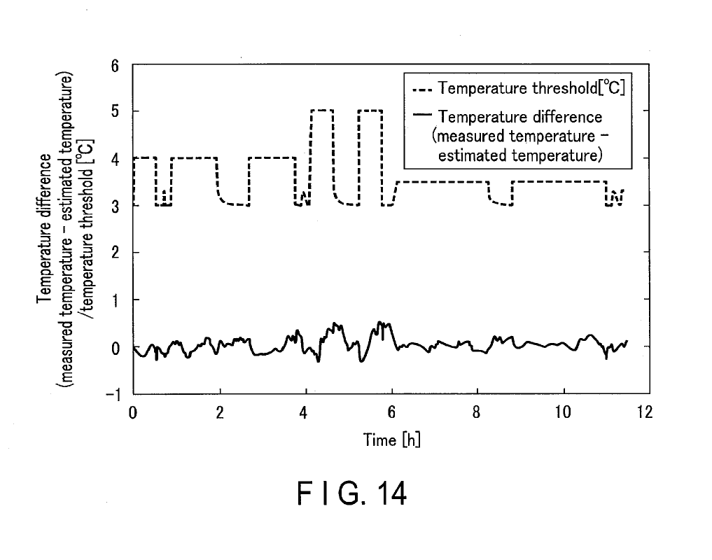

For example, the temperature threshold setting unit 133 may also determine the value of the temperature threshold in accordance with a linear function of the value of the measured electric current. If the value of the temperature threshold is determined as a linear function of the value of the measured electric current in the example shown in FIGS. 12 and 13 described above, the temperature threshold and temperature difference fluctuate as exemplarily shown in FIG. 14. In this example shown in FIG. 14, the temperature difference slightly increases in a period during which the charge/discharge current is large, and the temperature threshold also increases to a maximum of 5° C. as the electric current increases. Therefore, no temperature state determination error occurs even when the estimation error temporarily increases due to the current increase in a normal operation of the battery 100.

Note that an appropriate temperature threshold corresponding to each parameter depends on various factors such as the structure of the battery pack, the structure of the cell, the location of the temperature measurement point, and the settings of an apparatus using the battery. Furthermore, when the environmental temperature intensely fluctuates due to the influence of heat generation by a peripheral part (e.g., a motor) or a peripheral circuit of the battery pack, the estimation error may also largely fluctuate. Therefore, the temperature threshold is preferably set by taking account of the fluctuation in environmental temperature. For example, the temperature threshold setting unit 133 can suppress the occurrence of a temperature state determination error by increasing the absolute value of the temperature threshold in a period between when the peripheral part or circuit starts the operation and when the operation stabilizes or in a period during which a specific operation having a large load is performed.

The temperature state determination unit 134 receives the measurement data from the measurement unit 120, the estimated temperature from the temperature estimation unit 132, and the set temperature threshold from the temperature threshold setting unit 133. The temperature state determination unit 134 calculates the temperature difference between the measured temperature and estimated temperature, and compares the temperature difference with the temperature threshold, thereby determining the temperature state of the battery 100.

For example, when using one temperature threshold level, the temperature state determination unit 134 determines that the temperature state of the battery 100 is normal if the absolute value of the temperature difference is less than the temperature threshold, and determines that the temperature state is abnormal if not. If it is determined that the temperature state of the battery 100 is abnormal, a security unit (which can include the battery control unit 110) (not shown) can perform a predetermined security operation. For example, the battery control unit 110 as a security unit can perform, e.g., restriction of input/output power, stop of use (including emergency stop of use), inhibition of restart, or outside forced discharge of stored power, with respect to the battery 100. Alternatively, a display, loudspeaker, or lighting element as a security unit can notify the user of a caution, a warning, or a request for stopping the use of the apparatus using the battery, or the temperature state determination unit 134 can transmit a notification signal indicating abnormality to the host system as the security unit. Note that the security unit may cancel the security operation if the temperature state determination unit 134 re-determines that the temperature state of the battery 100 is normal.

On the other hand, when using two or more temperature threshold levels, the temperature state determination unit 134 determines that the temperature state of the battery 100 is normal if the absolute value of the temperature difference is less than a minimum temperature threshold, and determines that the temperature state of the battery 100 is abnormal if not. In addition, the temperature state determination unit 134 can stepwise determine whether the temperature state of the battery 100 has a low-risk abnormality or high-risk abnormality by sequentially comparing the absolute value of the temperature difference with larger temperature thresholds. In this case, the security unit can ensure the safety while maintaining the user's convenience as much as possible by selecting a security operation suitable for the risk. More specifically, if the temperature state is found to have a low-risk abnormality (i.e., the absolute value of the temperature difference is small), the user's convenience is given priority, and the use of the battery 100 is not particularly restricted although attention is attracted by the security unit or the like in order to encourage the user to conduct a test. On the other hand, if the temperature state is found to have a high-risk abnormality (i.e., the absolute value of the temperature difference is large), security is given priority, and the security unit or the like performs emergency stop of use, stored power forced outside discharge, or the like with respect to the battery 100.

Note that the temperature state determination unit 134 preferably determines the temperature state in real time (to be exact, with very little delay), but a slight delay may also be produced in order to, e.g., disperse the calculation load. More specifically, even in a situation in which the load fluctuation of the battery 100, the environmental change, the vibration, and the like are relatively intense, abnormal heat generation can be detected in a sufficiently early stage if the delay amount is about a few seconds to a few minutes. Also, when the battery 100 is used as, e.g., a power system storage battery and the load is moderate, the delay amount can be about a few hours to a few days. If the delay amount is large, however, it is favorable to use the conventional temperature protection device in order to take a measure against sudden abnormal heat generation.

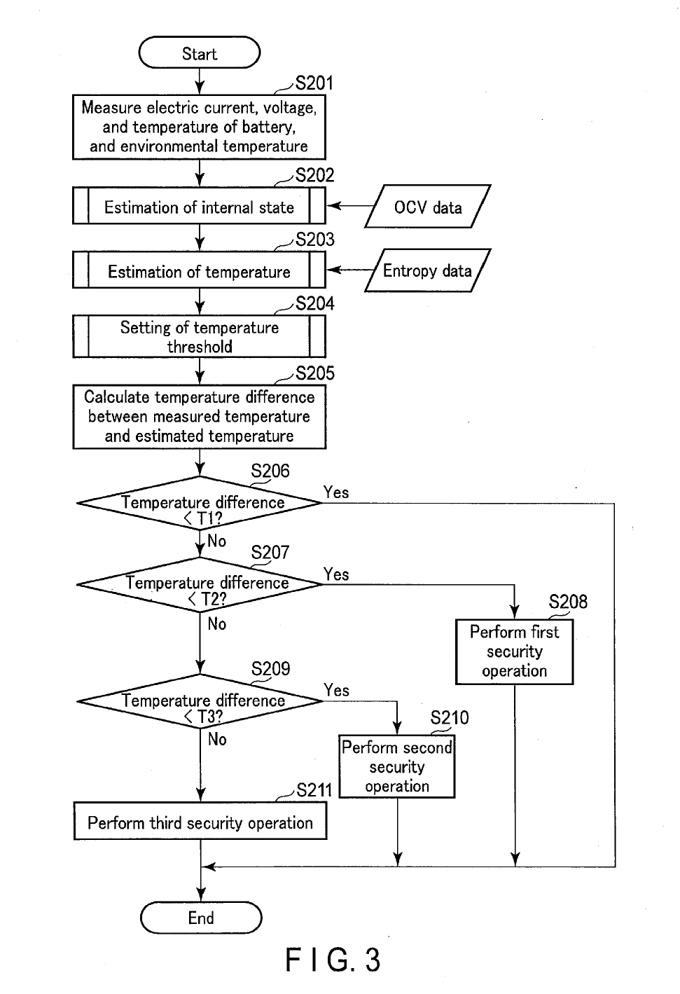

The battery pack shown in FIG. 1 operates as exemplarily shown in FIG. 3. Note that individual steps may also be executed in an order different from that shown in FIG. 3.

First, the measurement unit 120 measures the electric current, voltage, and temperature of the battery 100 and the environmental temperature (step S201). Then, the internal state estimation unit 131 estimates the internal state of the battery 100 by using the OCV data read out from the storage unit 140, and the measurement data obtained in step S201 (step S202).

Note that step S202 need not always be executed whenever the abnormal heat generation detection process shown in FIG. 3 is executed. That is, internal state parameters estimated when step S202 is executed in the past can be reused from step S203. Step S202 need only be executed at a frequency at which the estimation accuracy of the temperature estimation unit 132 does not decrease due to the influence of deterioration of a cell with time. For example, step S202 can be executed when measurement data suitable for charge/discharge curve regression analysis is newly obtained. Alternatively, it is also possible to regularly perform a predetermined charge/discharge operation on the battery 100, and execute step S202 based on measurement data obtained during the operation. The execution frequency of step S202 can be determined based on, e.g., the deterioration characteristic of the battery 100, the structure of the battery pack, an apparatus using the battery, and the use status of the battery 100.

The temperature estimation unit 132 thermologically estimates the theoretical temperature of the battery 100 based on the OCV data read out from the storage unit 140, the measurement data obtained in step S201, and the internal state parameters estimated in step S202 (step S203). Furthermore, the temperature threshold setting unit 133 sets at least one temperature threshold level based on the measurement data obtained in step S201 and the internal state parameters estimated in step S202 (step S204). In an example of step S204, the temperature threshold setting unit 133 sets three levels of temperature thresholds T1, T2, and T3 for which 0<T1<T2<T3.

The temperature state determination unit 134 calculates the temperature difference between the measured temperature of the battery 100 obtained in step S201 and the estimated temperature obtained in step S203 (step S205). Then, the temperature state determination unit 134 compares the temperature difference calculated in step S205 with the minimum temperature threshold (T1) set in step S204 (step S206). If the temperature difference is less than T1, the temperature state determination unit 134 determines that the temperature state of the battery 100 is normal, and terminates the abnormal heat generation detection process shown in FIG. 3.

If the temperature difference is T1 or more in step S206, the temperature state determination unit 134 further compares the temperature difference with the second smallest temperature threshold (T2) set in step S204 (step S207). If the temperature difference is less than T2, the temperature state determination unit 134 determines that the temperature state of the battery 100 has a low-risk abnormality, and performs a first security operation (step S208), thereby terminating the abnormal heat generation detection process shown in FIG. 3. The first security operation is preferably suitable for the level of risk estimated from the temperature state of the battery 100. For example, the security unit does not particularly restrict the use of the battery 100, but attracts attention in order to urge the user to conduct a test.

If the temperature difference is T2 or more in step S207, the temperature state determination unit 134 further compares the temperature difference with the maximum temperature threshold (T3) set in step S204 (step S209). If the temperature difference is less than T3, the temperature state determination unit 134 determines that the temperature state of the battery 100 has a medium-risk abnormality, and performs a second security operation (step S209), thereby terminating the abnormal heat generation detection process shown in FIG. 3. On the other hand, if the temperature difference is T3 or more, the temperature state determination unit 134 determines that the temperature state of the battery 100 has a high-risk abnormality, and performs a third security operation (step S210), thereby terminating the abnormal heat generation detection process shown in FIG. 3. The second and third security operations are also preferably suitable for the level of risk estimated from the temperature state of the battery 100. For example, as the third security operation, the security unit can perform emergency stop of use, stored power forced outside discharge, and the like on the battery 100. The second security operation is preferably selected by giving importance to security compared to the first security operation, and giving importance to the user's convenience compared to the third security operation.

As has been explained above, the battery pack according to the first embodiment thermologically estimates the theoretical temperature of the battery, and calculates the temperature difference between the estimated temperature and an actually measured temperature. If the temperature difference deviates from the temperature threshold, this battery pack determines that the temperature state of the battery is abnormal, and performs a security operation as needed. Accordingly, this battery pack can detect abnormal heat generation of the battery or its peripheral circuit or component in an early stage (before the battery temperature becomes very high). Furthermore, this battery pack can detect abnormal heat generation of the battery caused by an external factor not only when the battery is in use but also when it is not in use. It is possible to ensure the safety while maintaining the user's convenience by detecting abnormal heat generation in an early stage and performing an appropriate security operation.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A battery pack comprising:
a secondary battery;
a measurement unit configured to measure an electric current, a voltage, and a temperature of the secondary battery, and an environmental temperature outside the secondary battery to obtain measurement data;
an internal state estimation unit configured to estimate an internal state of the secondary battery based on the measurement data to obtain an estimation parameter;
a temperature estimation unit configured to estimate the temperature of the secondary battery based on the measurement data and the estimation parameter to obtain an estimated temperature; and
a determination unit configured to compare an absolute value of a temperature difference between a measured temperature of the secondary battery contained in the measurement data and the estimated temperature with one or more temperature threshold levels, and determine a temperature state of the secondary battery in accordance with a comparison result.

2. The pack according to claim 1, further comprising a setting unit configured to adjust the temperature threshold levels based on some or all of a measured electric current of the secondary battery contained in the measurement data, a measured environmental temperature contained in the measurement data, and SOC (State Of Charge) of the secondary battery contained in the estimation parameter, and set the adjusted temperature threshold levels.

3. The pack according to claim 1, wherein the determination unit compares the absolute value of the temperature difference with a first temperature threshold level which is a minimum of the temperature threshold levels, and determines that the temperature state of the secondary battery is normal when the absolute value of the temperature difference is less than the first temperature threshold level.

4. The pack according to claim 3, wherein the determination unit determines that the temperature state of the secondary battery is abnormal when the absolute value of the temperature difference is not less than the first temperature threshold level.

5. The pack according to claim 3, wherein the determination unit further compares the absolute value of the temperature difference with a second temperature threshold level of the temperature threshold levels, which is larger than the first temperature threshold level, when the absolute value of the temperature difference is not less than the first temperature threshold, determines that the temperature state of the secondary battery has a high-risk abnormality when the absolute value of the temperature difference is not less than the second temperature threshold level, and determines that the temperature state of the secondary battery has a low-risk abnormality when the absolute value of the temperature difference is not less than the first temperature threshold level and less than the second temperature threshold level.

6. The pack according to claim 5, further comprising a security unit configured to perform a first security operation including restriction of use of the secondary battery when the temperature state of the secondary battery is found to have a high-risk abnormality, and perform a second security operation not including restriction of use of the secondary battery when the temperature state is found to have a low-risk abnormality.

7. A control circuit comprising:
an internal state estimation unit configured to estimate an internal state of a secondary battery based on measurement data obtained by measuring an electric current, a voltage, and a temperature of the secondary battery, and an environmental temperature outside the secondary battery to obtain an estimation parameter;
a temperature estimation unit configured to estimate the temperature of the secondary battery based on the measurement data and the estimation parameter to obtain an estimated temperature; and
a determination unit configured to compare an absolute value of a temperature difference between the measured temperature of the secondary battery contained in the measurement data and the estimated temperature with one or more temperature threshold levels, and determine a temperature state of the secondary battery in accordance with a comparison result.

8. The circuit according to claim 7, further comprising a setting unit configured to adjust the temperature threshold levels based on some or all of a measured electric current of the secondary battery contained in the measurement data, a measured environmental temperature contained in the measurement data, and SOC (State Of Charge) of the secondary battery contained in the estimation parameter, and set the adjusted temperature threshold levels.

9. The circuit according to claim 7, wherein the determination unit compares the absolute value of the temperature difference with a first temperature threshold level which is a minimum of the temperature threshold levels, and determines that the temperature state of the secondary battery is normal when the absolute value of the temperature difference is less than the first temperature threshold level.

10. The circuit according to claim 9, wherein the determination unit determines that the temperature state of the secondary battery is abnormal when the absolute value of the temperature difference is not less than the first temperature threshold level.

11. The circuit according to claim 9, wherein the determination unit further compares the absolute value of the temperature difference with a second temperature threshold level of the temperature threshold levels, which is larger than the first temperature threshold level, when the absolute value of the temperature difference is not less than the first temperature threshold, determines that the temperature state of the secondary battery has a high-risk abnormality when the absolute value of the temperature difference is not less than the second temperature threshold level, and determines that the temperature state of the secondary battery has a low-risk abnormality when the absolute value of the temperature difference is not less than the first temperature threshold level and less than the second temperature threshold level.

12. The circuit according to claim 11, further comprising a security unit configured to perform a first security operation including restriction of use of the secondary battery when the temperature state of the secondary battery is found to have a high-risk abnormality, and perform a second security operation not including restriction of use of the secondary battery when the temperature state is found to have a low-risk abnormality.

13. A control method comprising:
estimating an internal state of a secondary battery based on measurement data obtained by measuring an electric current, a voltage, and a temperature of the secondary battery, and an environmental temperature outside the secondary battery to obtain an estimation parameter;
estimating the temperature of the secondary battery based on the measurement data and the estimation parameter to obtain an estimated temperature; and
comparing an absolute value of a temperature difference between the measured temperature of the secondary battery contained in the measurement data and the estimated temperature with one or more temperature threshold levels, and determining a temperature state of the secondary battery in accordance with a comparison result.

14. The method according to claim 13, further comprising adjusting the temperature threshold levels based on some or all of a measured electric current of the secondary battery contained in the measurement data, a measured environmental temperature contained in the measurement data, and SOC (State Of Charge) of the secondary battery contained in the estimation parameter, and setting the adjusted temperature threshold levels.

15. The method according to claim 13, further comprising comparing the absolute value of the temperature difference with a first temperature threshold level which is a minimum of the temperature threshold levels, and determining that the temperature state of the secondary battery is normal when the absolute value of the temperature difference is less than the first temperature threshold level.

16. The method according to claim 15, further comprising determining that the temperature state of the secondary battery is abnormal when the absolute value of the temperature difference is not less than the first temperature threshold level.

17. The method according to claim 15, further comprising comparing the absolute value of the temperature difference with a second temperature threshold level of the temperature threshold levels, which is larger than the first temperature threshold level, when the absolute value of the temperature difference is not less than the first temperature threshold, determining that the temperature state of the secondary battery has a high-risk abnormality when the absolute value of the temperature difference is not less than the second temperature threshold level, and determining that the temperature state of the secondary battery has a low-risk abnormality when the absolute value of the temperature difference is not less than the first temperature threshold level and less than the second temperature threshold level.

18. The method according to claim 17, further comprising performing a first security operation including restriction of use of the secondary battery when the temperature state of the secondary battery is found to have a high-risk abnormality, and performing a second security operation not including restriction of use of the secondary battery when the temperature state is found to have a low-risk abnormality.
